(19) United States
(12) Patent Application Publication
(10) Pub. No.: US 2010/0239901 A1
(43) Pub. Date: Sep. 23, 2010

(54) Separator for Lead Starved Storage Batteries

(75) Inventors: Silvano Menti, Monteviale (IT); Luigi Castagna, Castelgomberto (IT)

Correspondence Address: MAGINOT, MOORE & BECK, LLP;CHASE TOWER, 111 MONUMENT CIRCLE, SUITE 3250, INDIANAPOLIS, IN, 46204, US

(73) Assignees: RMB FIBERS AG, Niederweningen (CH); INDUSTRIE MAURIZIO PERUZZO - IMP S.A., Luxembourg (LU)

(21) Appl. No.: 12/767,287

(22) Filed: Apr. 26, 2010

Related U.S. Application Data
(63) Continuation of application No. PCT/IB2008/054401, filed on Oct. 24, 2008.

(30) Foreign Application Priority Data
Oct. 24, 2007 (IT) PD 2007A000355

(51) Int. Cl. H01M 6/42; H01M 2/16

(52) U.S. Cl. 429/149; 429/249

(57) ABSTRACT

A separator for lead starved storage batteries comprises at least one layer of nonwoven fabric made from fibres of one or more organic polymers. In at least one embodiment, the nonwoven fabric is made from staple fibres of polyester with count between 0.1 and 4 dTex. In at least one embodiment of the invention, a lead starved storage battery is provided with such separators.

### CROSS-REFERENCE TO RELATED APPLICATIONS

This application is a continuation of international application no. PCT/IB2008/054401, filed on Oct. 24, 2008 (and published on Apr. 30, 2009 as international publication no. WO 2009/053938).

### FIELD

The disclosure herein relates to a separator for lead starved storage batteries and a lead storage battery provided with such a separator.

### BACKGROUND

In lead hermetic recombination storage batteries, also known as “starved electrolyte” or AGM (Absorbed Glass Mat) batteries, a separator consisting of a fibreglass mat may be interposed between the positive and negative electrodes of each electrochemical couple.

The two electrodes consist of flat plates. The positive electrode is in lead dioxide (PbO₂) while the negative electrode is in spongy lead (Pb).

The combination of a positive plate with a separator and a negative plate constitutes the elementary electrochemical couple. Several superimposed electrochemical couples (the number of couples determines the capacity of the cell) constitute the elementary cell of a battery. The cell in turn is set in a solution of electrolyte (diluted sulphuric acid) which ensures electrical continuity and therefore permits the generation of a flow of current.

The fibreglass separator currently used has the function of electrically insulating the plates of opposite polarity.

The separator absorbs the electrolyte (diluted solution of sulphuric acid), maintaining it in liquid form in such a way as to render it available to electrochemical reaction. In fact in recombination batteries the electrolyte must not be free between the plates but completely absorbed in the separator.

The fibreglass separator moreover permits migration into it of the gases (hydrogen and oxygen) generated by electrochemical reactions, facilitating the recombination thereof. This essential function is made possible by the fact that the separator consists of very thin fibres (microfibres) which generate in the fabric a high porosity which is not saturated by electrolyte. This favours recombination of the gases developed by electrochemical reactions (hydrogen and oxygen are recomposed to create water).

The functioning cycle of a starved storage battery is as follows.

At the positive plates oxygen and hydrogen develop due to the effect of chemical decomposition of water:

H₂O→½O₂+2H⁺+2e⁻

The oxygen spreads through the microporous separator and migrates to the negative plate where it reacts with the spongy lead of the negative plate.

Pb+½O₂→PbO

On the negative plates the lead oxide reacts with the electrolyte, composed by a sulphuric acid solution, forming lead sulphate and water.

PbO+H₂SO₄→PbSO₄+H₂O

The charging process then turns the lead sulphate into lead and sulphuric acid, thus completing the recombination cycle.

PbSO₄+2H⁺2e⁻→Pb+H₂SO₄

The complete cycle of the battery/accumulator is as follows:

PbO₂+2H₂SO₄+Pb [symbol] PbSO₄+2H₂O+PbSO₄

Where the state of the charged battery is on the left and the state of the flat battery on the right.

In traditional starved storage batteries, during assembly the fibreglass separator is compressed between the two plates. Overall, each cell of the battery is assembled with a compression that normally must exceed 15 kPa.

In fact it is well known that during the cyclical processes of charging and discharging to which a storage battery is subject, the plates are subject to volume variations due to both temperature variations and electrochemical reactions. These volume variations determine “movements” of reciprocal distancing and approaching of the plates. In sector jargon this is called “breathing”.

To carry out its function properly the separator must follow these movements. Compression of the separator between the plates therefore has the function of allowing the separator to maintain close contact with the plates and between the plates and the absorbed acid.

One of the drawbacks of traditional starved storage batteries is connected with the fact that the fibreglass separator is not very elastic and, with time, does not guarantee constant behaviour in its ability to maintain optimal contact between plates and acid.

Another drawback is connected with the fact that manipulation of the fibreglass during the assembly steps must be carried out observing a series of precautions to avoid or limit contact between fibre and assembler. On the one hand this makes the production process costlier and on the other hand does not guarantee total assembler safety.

### SUMMARY

In at least one embodiment of the invention, the drawbacks of the above technique is be eliminated by supplying a separator for lead starved storage batteries which can guarantee greater constancy of behaviour in time with regard to maintaining close contact between the plates and the electrolyte absorbed by the separator.

In at least one embodiment of the invention a separator is provided for lead starved recombination storage batteries which increases their life and efficiency.

In at least one embodiment of the invention, a separator is provided for lead starved storage batteries which, during assembly, does not call for safety precautions on the assemblers' part.

In at least one additional embodiment of the invention, a separator is supplied for lead starved recombination storage batteries which is cheap to manufacture.

### BRIEF DESCRIPTION OF THE DRAWINGS

The technical features of at least one embodiment of the invention, can be clearly understood from the contents of the claims below. The advantages will be made even clearer by the detailed description that follows, with reference to the attached drawings which represent, purely by way of example and in no way limitative, one embodiment and form of implementation of the invention:

FIG. 1 shows the schematic view of an elementary electrochemical couple for lead starved recombination storage batteries with a separator in accordance with at least one embodiment of the invention;

FIG. 2 is the schematic drawing of a crimped fibre;

FIG. 3 shows a schematic representation of the structure of a nonwoven fabric used for making a separator in accordance with at least one embodiment of the invention; and

FIG. 4 shows a schematic section view of a splittable type fabric.

### DESCRIPTION

With reference to the attached drawings, number 1 indicates overall a separator for lead starved recombination storage batteries in accordance with at least one embodiment of the invention.

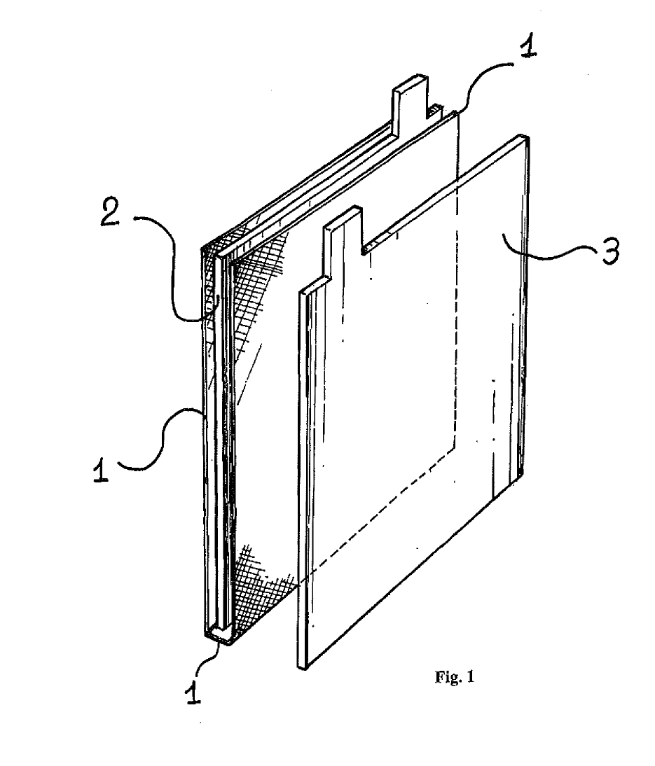

Separator 1, the subject of the disclosure herein, is designed to be interposed between two plates of opposite polarity which form an elementary electrochemical couple for a lead starved storage battery. In FIG. 1 the positive plate is indicated by 2 and the negative by 3.

In accordance with the embodiment illustrated in FIG. 1, the separator 1 has, essentially, a sheet form and is folded in two in such a way as to house positive plate 2 inside. In this way positive plate 2 is electrically insulated on both sides and at the bottom.

In accordance with an alternative embodiment (not illustrated in the attached figures) separator 1 may envelop the negative plate.

In accordance with another embodiment, separator 1 is an unfolded sheet which is simply inserted between the two plates.

Advantageously, the separator may be inserted between two flat type plates that form an elementary electrochemical couple for a lead starved storage battery.

The separator in question may be advantageously interposed also between two plates of which the negative is flat while the positive is of the tubular type.

In the latter case separator 1, in accordance with at least one embodiment of the invention, is able, thanks to its elastic behaviour (which will be dealt with in detail below) to adapt to the non-flat surface conformation of the positive plate. The separator thus plays a fundamental role in maintaining contact between the absorbed electrolyte and the tubular type positive plate.

The expression “lead hermetic recombination storage battery” is intended to include, in particular, accumulators or batteries known as “starved” or “starved electrolyte” or AGM (Absorbed Glass Mat), without however any limitation to their specific field of application, for example stationary, traction and automobile.

In accordance with at least one embodiment of the invention the separator comprises at least one layer of nonwoven fabric made from the fibres of one or more organic polymers.

In accordance with at least one preferred embodiment of the invention the separator consists simply of a layer of nonwoven fabric made from the fibres of one or more organic polymers.

The expression “organic polymers” refers in particular to polymers classifiable as plastic materials.

Advantageously, the aforementioned polymers are selected from acid-resistant materials.

Preferably, but not necessarily, the above organic polymers are polyesters and/or polypropylene.

The nonwoven fabric may be either fibres of one type of polymer only or a mixture of fibres of two or more different polymers (e.g. polyesters and polypropylenes).

As will be reprised below, bicomponent fibres may also be advantageously used, preferably but not necessarily polyester.

In accordance with at least one preferred embodiment of the invention, the nonwoven fabric is made only from fibres of polyester and/or mixtures thereof.

Functionally, the separator in accordance with at least one embodiment of the invention is intended to replace the fibreglass separator traditionally used in starved batteries, carrying out all its functions.

The separator in accordance with at least one embodiment of the invention offers a series of advantages.

A first advantage lies in the fact that the separator in accordance with at least one embodiment of the invention, unlike traditional fibreglass separators, can follow the movements of dilation and contraction of the paste during the charging and discharging cycles.

In fact experiments have shown that the separator in accordance with at least one embodiment of the invention has greater elasticity than a fibreglass separator of the same thickness. In particular it was noted that the separator in accordance with at least one embodiment of the invention maintains constant elasticity in time.

In other words, the separator in accordance with at least one embodiment of the invention, when it is not subject to forces of compression, regains its initial thickness, which is to say the thickness it had when assembled.

Operationally, when the active material dilates due to electrochemical transformations, the separator is compressed under the thrust of the paste; when the active material contracts, the separator—thanks to its elastic properties—dilates and returns to its original form. So the separator can follow the contraction and expansion of the active material, known as “breathing”.

All of this means that the separator can maintain constant and close contact with the active material of the positive and negative electrodes and therefore carry out its functions in a more efficacious and effective way than a traditional fibreglass separator.

As already mentioned, a traditional fibreglass separator, once compressed, tends on the contrary to retain its compressed form and cannot return to its original dimensions. In the life of a battery the traditional fibreglass separator therefore tends to lose close contact with the active material, making a negative contribution to battery duration.

As will be dealt with below, the elastic behaviour of the separator derives from the elastic microporous (or alveolar) structure of the nonwoven fabric that comprises at least one layer of the separator.

A second advantage, with regard to correct battery functioning, derives from the fact that thanks to these elastic properties, during the step of assembling the individual elementary cells, the separator need be compressed only to a maximum of 5 KPa. Indeed it may be that no compression whatsoever is required.

It is further pointed out that, at least in theory, no compression need be applied to the overall complex of cells.

The characteristics of elasticity and resilience of the separator itself mean that it can follow the movements of the plates during the charging and discharging cycles throughout the average life of the battery, making separator precompression superfluous. This makes battery assembly simpler and less expensive.

Batteries with traditional fibreglass separators, contrarily, must be assembled with compression greater than 15 Kpa, this in an attempt to compensate for the lack of elasticity in the separator. This is obviously detrimental to ease and cheapness of assembling the batteries. The traditional compression operation is moreover inefficacious since fibreglass separators, in spite of initial compression, tend to lose contact with the active material of the electrodes and therefore do not follow the contraction and expansion movement of the active material.

A third advantage is the fact that the separator in accordance with at least one embodiment of the invention favours the gas recombination cycle, thus making battery functioning more efficient.

In fact experiments have shown that the separator has greater gas absorption capacity than a traditional fibreglass separator.

As will be resumed below, this derives from the microporous (or alveolar) structure of the nonwoven fabric which forms at least one layer of the separator.

In demonstration of the previous it was observed in batteries provided with separators in accordance with at least one embodiment of the invention that at every discharge of a battery the subsequent recharging to floating voltage envisaged for starved batteries guaranteed complete recharging and maintenance at charged state for an indeterminate period.

A fourth advantage derives from the fact that the separator in accordance with at least one embodiment of the invention contains no substances that are harmful through contact or inhalation (such as glass or asbestos fibres). This means an improvement in safety conditions for assemblers of the individual cells. Since no special precautions are required during separator handling, battery assembly is simpler and cheaper.

All of this means that the separator in accordance with at least one embodiment of the invention can carry out its functions more efficaciously and efficiently than a traditional fibreglass separator.

Advantageously, the nonwoven fabric of the separator can be made with any of the well known manufacturing techniques, such as for example carding associated with interlacing, the latter being needle punched, with or without resining, spunlace or steamlace. Alternatively the meltblow or spunbond techniques may be employed.

In accordance with a preferred embodiment in a general form, the production process of the nonwoven fabric for the separator comprises the following main operational steps:
carding of the fibres to obtain webs of fibres,
layering of the fibre webs in output from carding in order to obtain a mat of superimposed webs;
mechanical lacing of the carded fibre webs overlaid to form the mat.

Mechanical lacing may be carried out by the needle punch, spunlace or steamlace techniques. Combinations of these three different techniques may be envisaged.

In greater detail, in the steamlace technique, for the generation of steam jets the nozzles used are similar to those used in spunlace technology (needle punched with liquid water). The steam is overheated to avoid condensation in the product. A drying step after lacing is not required.

Preferably, subsequent to the mechanical lacing step, a step of thermostabilisation of the mat is envisaged.

More in detail, during the thermostabilisation step the mat (which has already undergone mechanical lacing) is put through a ventilated kiln.

Thermostabilisation exploits the so called “shape memory” of certain organic polymers (especially polyesters and polypropylenes) on the basis of which a polymer which has undergone heat treatment at a certain temperature (lower than that of softening/fusion) will, even if subjected to subsequent heat treatments, continue to maintain good dimensional stability until the thermostabilisation treatment temperature is exceeded. This contributes further to giving the nonwoven fabric an accentuated capability of maintaining its dimensional form following heat stresses.

Operationally, as will be dealt with in detail below, should the mat be formed of different types of fibre, the thermostabilisation temperature is selected in function of the fusion temperatures of the lowest melting point fibres and of the degree of thermostabilisation desired for the highest melting point fibres.

Advantageously, it is possible to envisage a fibre solidarization step in addition to the mechanical lacing step.

In greater detail, solidarization of the fibres may be achieved by thermal bonding and/or resining.

In greater detail, solidarization by thermal bonding requires that at least a fraction of the fibres used for the mat are thermobinding fibres (also called thermoformable).

Operationally, thermobinding (or thermoformable) fibres are selected which have softening and melting temperatures lower than those of the other fibres in the mixture.

Thermoformable fibres may be, for example, in low melting point polypropylene or polyester (e.g. around 160° C.), hypothesising for example that the other fibres are in high melting point polyester (e.g. around 260° C.).

Preferably bicomponent fibres are used as thermobinding fibres, and preferably of the polyester base type, for example with polyester sheath melting at a temperature between 110° C. and 160° C., hypothesising that the remaining fibres are in high melting point polyesters (e.g. around 260° C.).

The term “bicomponent fibre” means in general fibres composed by at least two types of polymer with different melting points.

Preferably, but not necessarily, the bicomponent fibres employed are formed by two coaxially extruded polymers, with the high melting point polymer central and the low melting point polymer external.

The arrangement of the polymers in the filiform structure of the fibre should not be understood as limitative. In fact bicomponent fibres with a non-coaxial distribution of the two polymers may also be advantageously used. For example, bicomponent fibres in which portions of one polymer and portions of the other are alternated longitudinally.

Advantageously, when the solidarization step is carried out by thermal bonding, it coincides with the step of thermostabilisation and is carried out in the same kiln.

In this case the thermostabilisation temperature is selected in function of the melting temperature of the external sheath of the thermofusible bicomponent fibre and in function of the degree of thermostabilisation to be given to the high melting point fibres. For example, if the mat is a mixture of bicomponent fibres with sheath in polyester melting at 160° C. and monocomponent fibres in polyester melting at 260° C., the kiln temperature (thermostabilisation/thermal bonding temperature) should preferably be between 180-200° C. and may reach the softening temperature of the high melting point polyester.

The use of bicomponent thermobinding fibres has proved to be ideal for creating a microporous type structure with reciprocally solidarized fibres.

In greater detail, following the step in the kiln and subsequent cooling, the bicomponent fibres build “connecting bridges” with the high melting point fibres.

This effect is made possible by the sheath-core type structure of the bicomponent fibres. The core of the fibres in polymers not sensitive to the thermal bonding temperatures (e.g. polymers with melting point of 260° C.) guarantees the necessary mechanical consistency of the aforementioned “connecting bridges”, while the sheath, made of polymers sensitive to the thermal bonding temperatures (e.g. polyester with melting point between 110° and 160° C.), softening and perhaps melting, ensures adhesion capacity between the core and the contiguous fibres.

Solidarization by resining requires that the mat should undergo impregnation with bonding resins.

The degree of impregnation is selected in function of the degree of rigidity acceptable for the mat.

To this end styrol-butadiene resins and/or acrylic resins may be used.

Resining should preferably be carried out at the end of the production process. In this case the solidarization step is distinct from the thermostabilisation step.

In cases where there is a combination of thermal bonding and resining, solidarization is carried out in two different steps of the process, which is to say during the thermostabilisation step and at the end of the production process.

In accordance with a particular embodiment of implementation, the production process comprises a step of calendering the mat. This step is preferably carried out after the mechanical lacing step and after the thermostabilisation step (where envisaged).

Calendering is preferably carried out hot and with the purpose of making both mat faces smooth. This makes a favourable contribution to the elastic behaviour of the separator if associated with the use of crimped fibres, which will be referred to below.

The temperature of the calenders is selected in function of the softening and melting temperatures of the fibres employed, in such a way that at least a part of the fibres set on the surface of both faces of the mat, softening or melting, can be formed by the calenders.

The calendering step is preferably envisaged in cases where thermobinding fibres are used. The presence of low melting point fibres (thermobinding) and high melting point fibres in fact permits smoothing the surfaces of the mat, creating a cohesive layer which still has high porosity.

In greater detail, the temperature of the calenders is selected in function of the percentage of thermobinding fibre and its related melting point.

For example, in the case of a mixture with 10% in weight of bicomponent fibres 2.2 dTex with sheath in polyester melting at around 160° C. and core in polyester melting at around 260° C., 10% weight of monocomponent fibres in polyester 3.6 dTex melting at around 260° C. and 80% weight of monocomponent fibres in polyester 0.8 dTex melting at around 260° C., the temperature of the calenders is selected between 180-200° C. During the treatment, which for both faces of the mat involves only a surface layer, there will be only the fusion of the low melting point fibres and any partial softening of the high melting point fibres. The high melting fibres will continue to maintain their fibriform structure and avoid the formation of a melted continuous surface layer. In this way a porous, smooth surface will be achieved.

Jointly with adoption of the production process described above in its various applicative forms, it is particularly advantageous to make the nonwoven fabric out of staple fibres, and in particular low count staple fibres (as will be dealt with below). In fact the nonwoven fabric has proved to possess especially accentuated characteristics of resilience, capillarity and absorption with regard to the gases.

“Staple fibres” is intended in general to mean fibres cut into small “cropped pieces” (or short fibres) which are loose and therefore without any determined or preferential lay.

In the specific case, referring to the fact that the nonwoven fabric is made from staple fibres, this should not exclude that in the final fabric the fibres may also have a determined or preferential lay.

Preferably, the nonwoven fabric which forms at least one layer of the separator in accordance with at least one embodiment of the invention is made from low count fibres, which is to say with count between 0.1 dTex and 4 dTex. Preferably the fibres have a count no greater than 3 dTex.

The use of fibres with count less than 4 dTex results in a nonwoven fabric whose structure has a high level of microporosity.

In accordance with particularly preferred embodiments, the fibres employed have count between 0.1 and 0.5 dTex and between 0.8 and 2.5 dTex. Fibres with count in these two ranges may be used either separately or mixed together.

Advantageously, mixtures may be envisaged comprising fibres with count between 2.5 and 4 dTex.

In accordance with a first general embodiment variant the nonwoven fabric—with regard to weight in fibre—has from 75% to 95% monocomponent fibres in polyester with count between 0.8 and 2.5 dTex, from 5% to 15% of bicomponent fibres and from 0% to 15% of monocomponent fibres in polyester with count between 2.5 and 4 dTex.

In accordance with a second general embodiment variant the nonwoven fabric—with regard to weight in fibre—has from 70% to 100% with count between 0.1 and 0.5 dTex, from 0% to 30% of monocomponent fibres in polyester with count between 0.8 and 2.5 dTex, from 5% to 15% of bicomponent fibres, from 0% to 20% of bicomponent fibres and from 0% to 20% monocomponent fibres in polyester with count between 2.5 and 4 dTex.

As already mentioned, a particular embodiment may be envisaged in which the fibres consist 100% of fibres with count between 0.1 and 0.5 dTex.

Especially advantageous is the use of microfibres, which is to say with count between 0.1 and 0.5 dTex. The presence of microfibres enhances microporosity of the nonwoven fabric, with a consequent increase in capillarity. So the absorption capacities of the nonwoven fabric with regard to the solution are improved, as well as the capacity to keep the acid solution uniformly distributed throughout the separator even when set vertically. In this way stratification of the solution is avoided during use of the storage battery.

By way of example, for a separator 1 in accordance with at least one embodiment of the invention, consisting of a layer of nonwoven fabric in microfibres with an average count of 0.14 dTex (obtained from fibres with count of 2.2 dTex splittable in 16 lunes in polyester-polypropylene), water absorption was between 4.5 and 8 grams of water per gram of fibre. The data refer to a nonwoven fabric having a basis weight between 180-200 g/m² and a thickness of 0.8 mm at a pressure of 5 KPa (corresponding to a thickness of 1 mm at a pressure of 0.5 KPa with reference to standard ISO 9073-2).

It was noted that the use of bicomponent thermobinding staple fibres results in a nonwoven fabric with a microporous (or alveolar) structure with particularly outstanding characteristics of elasticity and absorption capacity.

In greater detail, as described above, following the period in the kiln and subsequent cooling, the bicomponent fibres (thanks to their sheath-core type structure) become “connecting bridges” between the high melting point materials. The fibres are thus solidarized (accentuating their elastic return features) in an alveolar (or microporous) structure.

Advantageously, in order to obtain a microporous structure with outstanding elastic features the nonwoven fabric is created with a part of crimped type fibres.

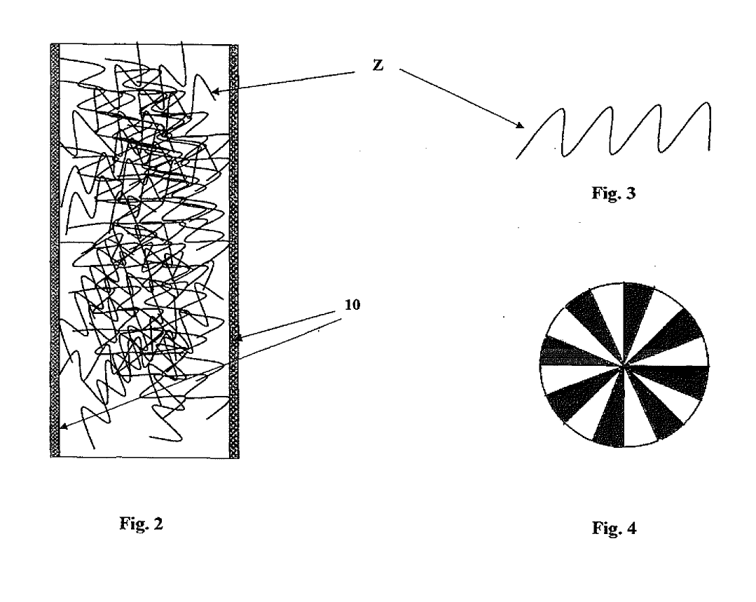

Crimping is a work process that gives the fibres an undulating form. FIG. 2 is a schematic illustration, purely by way of example, of the undulating form of a crimped fibre, indicated by the letter Z.

Preferably, the degree of crimping of the fibres (defined as the number of waves per unitary length of fibre) is not less than 4 waves/cm.

In accordance with a preferred embodiment the degree of crimping is no less than 4 waves/cm, the fibres having a count between 0.8 and 2.5 dTex.

Functionally, the undulated structure gives elastic properties to the individual fibre. Within the nonwoven fabric, the solidarized fibres operate like springs, countering deformations of the fabric.

Advantageously, the elasticity given by the crimped fibres and the bonding effect given by the thermobinding fibres (especially by the bicomponent fibres) contribute synergically to the formation of a nonwoven fabric with an elastic (microporous) structure.

As mentioned previously, this microporous elastic structure, especially if made with a part of thermobinding fibres and crimped fibres, gives this nonwoven fabric—which forms at least one layer of the separator—a very high capacity of absorption of the acid solution (used in lead storage batteries) and optimal elastic properties.

As mentioned previously, the “spring effect” of the fibres is accentuated when the faces of the nonwoven fabric mat are smoothed by hot calendering. The cohesive structure of the smoothed surface layers allows the fibres to cooperate synergically and exert the spring effect homogeneously over the whole surface of the separator.

FIG. 3 gives a schematic representation, purely by way of example, of the structure of the nonwoven fabric in accordance with at least one embodiment of the invention. The single crimped fibres are indicated by the letter Z, while the smoothed faces are indicated by the number 10.

Preferably, the introduction into the mixture of microfibres with count less than 0.15 dTex is obtained using a special type of fibre known in the sector as “splittable”.

In greater detail, splittable fibres have a substantially circular radial section. Each fibre is constituted by portions (e.g. in the form of lunes) of two different polymers which alternate to form the fibre (as illustrated schematically in FIG. 4). The different portions are held together by the electrostatic interaction between the two types of polymer used.

Operationally, during the production process of the nonwoven fabric, the splittable fibres are treated in such a way as to bring about separation of the various portions to create microfibres with count less than that of the initial composite fibre.

Preferably splittable fibres with count between 1.7 and 2.2 dTex are used.

For example in the case of a fibre with average formal count of 2.2 dTex and composed of 16 lunes we can obtain microfibres with count of about 0.14 dTex.

Preferably, the separation of the splittable fibres is carried out during the mechanical lacing step, employing the lacing system with high pressure water jets. High pressure water jets in fact separate the lune filaments composing the splittable fibres.

Advantageously, splittable fibres consisting of couples of polymers are used, both acid-resistant, such as polyester-polypropylene.

Splittable fibres may be used alone or in a mixture with monocomponent and/or bicomponent fibres with count between 0.8 and 3.3 dTex, this with view to increasing the spring effect. In the latter case the percentage of non-splittable fibre is between 10 and 30% in fibre weight.

Advantageously, the fibres used for creation of the nonwoven fabric which forms at least one layer of the separator in accordance with at least one embodiment of the invention have a length between 30 and 80 mm.

Advantageously, the nonwoven fabric (density being equal) has a basis weight between 50 g/m² and 700 g/m², and preferably between 80 g/m² and 500 g/m².

The thickness of the nonwoven forming the separator may however vary between 0.8 mm and 7 mm, and preferably between 1 mm and 5 mm, in function of the type of fibre used and the characteristics of the storage battery.

In accordance with at least one embodiment, the layer of nonwoven fabric of the separator is made with a production process that comprises a step of needle punching and a step of fibre solidarization by thermal bonding.

More in detail, composition of the fibres is as follows:
90% polyester fibre, count 0.8 dTex;
10% bicomponent polyester fibre (thermobinding), count 2.2 dTex.

Preferably, the needle punching step is carried out with the following operational parameters: from 120 to 160 needle punching points/cm² and from 200 to 900 needle punching strokes/min. The parameters are in function of the basis weight to be obtained for the final nonwoven.

The thermal bonding step is carried out by passing the nonwoven through the kiln at temperatures between 170° C. and 210° C., variable (as described above) in function of the polymeric material of which the fibres are composed.

The average overall speed at which the product being worked (fibres, veils, mat) passes through the work stations of carding, layering, needle punching and thermal bonding should preferably be between 3 and 12 m/min, in function of the basis weight desired for the final nonwoven.

A variant of the preferred embodiment described above envisages the following composition of the fibres:
80% polyester fibre, count 0.8 dTex;
10% bicomponent polyester fibre (thermobinding), count 2.2 dTex;
10% polyester fibre, count 3.6 dTex.

Tests were carried out to determine the elastic properties of the nonwoven fabric which forms at least one layer of the separator.

To this purpose tests were carried out in accordance with the standard defined by UNI 10171 for determination of compressibility and delayed elastic recovery and with the standard defined by UNI 10172 for determination of compressibility and delayed elastic recovery following dynamic fatigue.

In greater detail, the UNI 10171 tests envisage test samples of 40×40 cm with a minimum thickness of 50 mm (obtained by overlaying several samples). The test consists in: —measuring the thickness s1 of the sample under a weight of 20 Pa; —measuring the thickness s2 five minutes after adding a further weight of 480 Pa (for an overall weight of 500 Pa); —measuring the thickness s3 five minutes after removing the weight of 480 Pa. Static compressibility is given by (s1−s2)/s1×100, while delayed elastic recovery is given by s3/s1×100.

The tests in accordance with standard UNI 10172 envisage test samples of 40×40 cm with a minimum thickness of 50 mm (obtained by overlaying several samples). The test consists in: —measuring the thickness s1 of the sample under a weight of 20 Pa; subjecting the material to compression for 20.000 cycles with a weight of 550 Pa; —measuring the thickness s4 five minutes after adding a weight of 500 Pa (20+480 Pa); —measuring the thickness s5 five minutes after removing the weight of 480 Pa. Compressibility after dynamic fatigue is given by (s1−s4)/s1×100, while delayed elastic recovery after dynamic fatigue is given by s5/s1×100.

The nonwoven fabric that forms at least one layer of the separator has demonstrated an average compressibility (considering the different variants in terms of basis weight, composition and fibre count) greater than 4-6% and a delayed elastic recovery greater than 94-96%. After dynamic fatigue compressibility was on average greater than 4-6% and delayed elastic recovery greater than 93-95%.

Here below elasticity values for three specific nonwovens made in accordance with at least one embodiment of the invention are given.

Samples of a first non-woven fabric—having a basis weight of around 560 g/m² and a thickness at 5 kPa of about 4.5 mm—were undergone to the test described above. The non-woven fabric had the following fibre composition: —80% in weight of polyester fibre with melting point 260° C., count 0.8 dTex, length 38 mm and crimping degree of about 4 waves/cm; —10% in weight of polyester fibre with melting point 260° C., length 60 mm and count 3.6 dTex; —the remaining 10% in weight, bicomponent fibres in polyester with sheath melting at around 160° C. and core at about 260° C., count 2.2 dTex, length 51 mm and crimping degree of around 4 waves/cm. The production process of the nonwoven involved carding, needle punching and thermal bonding. The needle punching was carried out with 145 needle punching points/cm² and 500 needle punching strokes/min. Thermal bonding was carried out in a ventilated kiln at a temperature of around 175° C.

The tests carried out in accordance with standard UNI 10171 evinced a compressibility of 7-9% and a delayed elastic recovery of 94-96%. The tests carried out in accordance with standard UNI 10172 evinced, after dynamic fatigue, a compressibility of 7-9% and a delayed elastic recovery of 93-95%.

Elasticity tests were carried out on samples of a second nonwoven having a basis weight around 170 g/m² and a thickness at 5 kPa of about 1.5 mm. The nonwoven had the following fibre composition: —80% in fibre weight in polyester with melting point 260° C., count 0.8 dTex, length 38 mm and degree of crimping around 4 waves/cm; —10% in fibre weight of polyester with melting point 260° C., length 60 mm and count 3.6 dTex; —the remaining 10% in weight of bicomponent fibres with sheath melting at around 160° C. and core at about 260° C., length 51 mm, count 2.2 dTex and crimping degree of about 4 waves/cm. The production process of the nonwoven involved carding, needle punching and thermal bonding. The needle punching was carried out with 115 needle punching points/cm² and 650 needle punching strokes/min. Thermal bonding was carried out in a ventilated kiln at a temperature of around 175° C.

The tests carried out on this second nonwoven in accordance with standard UNI 10171 evinced a compressibility of 12-14% and a delayed elastic recovery of 94-96%. The tests in accordance with standard UNI 10172 evinced, after dynamic fatigue, a compressibility of 10-12% and a delayed elastic recovery of 93-96%.

Elasticity tests were carried out on samples of a third nonwoven fabric having a basis weight of 180-200 g/m² and a thickness of 0.8 mm (measured with a pressure of 5 KPa). The nonwoven was created with splittable 16 lune polyester-polypropylene microfibres, count 2.2 dTex and length 51 mm (split fibres formally have an average count of 0.14 dTex). The splittable fibres are composed of 65% polyester in weight, the remaining 35% in weight being polypropylene.

In particular the production process envisaged a lacing step with pressurised water jets (hydro-entanglement or spunlace). The pressure parameters of the hydro-entanglement system were appropriately adjusted to permit splitting of the microfibres. The degree of cohesion of the microfibres is a function of the thickness of the nonwoven.

At the end of the process the nonwoven underwent a drying step in a ventilated kiln at a temperature around 150-170° C. This step permitted thermostabilisation of the nonwoven.

The tests carried out on the samples of the third nonwoven in accordance with standard UNI 10171 showed a compressibility of 4-6% and a delayed elastic recovery of 94-96%. The tests in accordance with standard UNI 10172 showed, after dynamic fatigue, a compressibility of 4-6% and a delayed elastic recovery of 96-98%.

The compressibility and delayed elastic recovery data gathered from the samples of the three nonwoven fabrics made in accordance with at least one embodiment of the invention are indicative of the optimal elastic and resiliency properties of the separator.

Water absorption tests were carried out on samples of nonwovens created in accordance with at least one embodiment of the invention. The tests involved immersion of the samples in water for 60 seconds. Removed from the water the samples were left vertically to drip for 5 minutes. On completion of this operation the wet sample was weighed and compared with the dry sample.

The absorption tests showed that the nonwovens, in the variants described, irrespective of the basis weight, composition and count of the fibres, increased their weight by at least 800% on completion of dripping.

The compressibility and delayed elastic recovery data for the three samples of nonwovens are indicative of the good properties of absorption and retaining of the acid solution of the electrolyte.

Moreover, the disclosure herein concerns a lead starved storage battery which comprises a plurality of electrochemical cells. Each cell in turn comprises a plurality of electrochemical couples with two elements of opposite polarity. For at least one of these electrochemical couples, a separator in accordance with at least one embodiment of the invention is interposed between the two elements.

The two elements of opposite polarity which constitute a single electrochemical couple may both consist of a flat plate element or, alternatively, a flat plate element (negative electrode) and a tubular type element (positive electrode).

Surprisingly it was noted that, especially in lead storage batteries with tubular type positive electrodes, the behaviour of the separator is surprisingly favourable when the electrolytic solution (preferably based on diluted sulphuric acid) contains silica (SiO₂).

Preferably the silica used is of the kind known in the field as “fumed silica”.

The presence of silica (SiO₂) in the solution contributes to maintaining uniformity of concentration of the acid solution at the various filling levels of the battery, thus combating phenomena of stratification of the acid in the solution.

Accentuation of the separator characteristics are particularly notable when the silica (SiO₂) in the solution has a weight percentage of the acid solution between 0.5% and 7%.

Preferably, the percentage of silica in the solution should be between 2% and 5%, and even more preferably 3%.

Obviously in its practical implementation different embodiments of the invention may take on forms and configurations different from the one illustrated above, yet without going beyond this context of protection.

What is claimed is:

1. A device for a lead starved storage battery having at least two elements of opposite polarity, the device comprising:
a separator configured to be positioned between the at least two elements of opposite polarity, the separator comprising at least one layer of nonwoven fabric made from one or more organic polymers.

2. The device of claim 1 wherein said organic polymers are plastic materials.

3. The device of claim 2 wherein said organic polymers comprise polyesters and polypropylene.

4. The device of claim 1 wherein said nonwoven fabric consists of 100% polyesters.

5. The device of claim 1 wherein said nonwoven fabric is comprised of fibres and production of the nonwoven fabric comprises:
carding said fibres;
passing the carded fibres in a stratifier to obtain a mat formed of layers of carded fibres; and
mechanically lacing said mat.

6. The device of claim 5 wherein mechanically lacing is carried out by needle punching, spunlacing or steamlacing.

7. The device of claim 5 wherein said production of the nonwoven fabric further comprises solidarizing said fibres laid in said mat, wherein said solidarizing is carried out by thermal bonding or resining.

8. The device of claim 5 wherein said production of the nonwoven fabric comprises calendaring of said mat.

9. The device of claim 1 wherein said nonwoven fabric is comprised of fibres and said fibres comprise thermobinding fibres, and said thermobinding fibres comprise bicomponent fibres or polypropylene fibres.

10. The device of claim 1 wherein said nonwoven fabric is comprised of fibres and said fibres have a count between 0.1 and 3 dTex.

11. The device of claim 10 wherein at least some of said fibres have a count between 0.1 and 0.5 dTex.

12. The device of claim 10 wherein at least some of said fibres have a count between 0.8 and 2.5 dTex.

13. The device of claim 1 wherein said nonwoven fabric is comprised of fibres having a length between 30 and 80 mm.

14. The device of claim 1 wherein said separator has a basis weight between 80 g/m2 and 500 g/m2 and a thickness between 1 mm and 5 mm.

15. The device according to claim 1 wherein said nonwoven fabric is comprised of fibres having a crimping degree of not less than 4 waves/cm and a count between 0.8 and 2.5 dTex.

16. The device of claim 1 wherein said nonwoven fabric is comprised of fibres, wherein from 75% to 95% of fibre weight is provided by monocomponent polyester fibres with a count between 0.8 and 2.5 dTex, wherein from 5% to 15% of fibre weight is provided by bicomponent fibres, and wherein from 0% to 15% of fibre weight is provided by monocomponent polyester fibres with a count between 2.5 and 4 dTex.

17. The device of claim 1 wherein said nonwoven fabric is comprised of fibres, wherein from 70% to 100% of fibre weight is provided by fibres with a count between 0.1 and 0.5 dTex, wherein from 0% to 30% of fibre weight is provided by monocomponent polyester fibres with a count between 0.8 and 2.5 dTex, wherein from 0% to 20% of fibre weight is provided by bicomponent fibres, and wherein from 0% to 20% of fibre weight is provided by monocomponent polyester fibres with a count between 2.5 and 4 dTex.

18. The device of claim 1 wherein the separator is in the form of a sheet interposed between the two opposite polarity elements of the lead starved storage battery, wherein said sheet is folded substantially in two to form a pocket to house one of the two opposite polarity elements that form an elementary battery cell.

19. A lead starved storage battery comprising:
a plurality of electrochemical cells, each electrochemical cell comprising a plurality of electrochemical couples with two elements of opposite polarity; and
a separator interposed between the two elements of opposite polarity in at least one of said electrochemical couples.

20. The lead starved storage battery of claim 19 further comprising an electrolytic solution based on a diluted sulphuric acid solution having silica (SiO2) in solution, wherein said silica is in solution with a weight percentage between 2% and 5%.
